(19) United States
(12) Patent Application Publication
(10) Pub. No.: US 2005/0158160 A1
(43) Pub. Date: Jul. 21, 2005

(54) Drop frame refuse collection vehicle

(76) Inventors: Gary L. Johnson, Ft. Payne, AL (US); Gary Flerchinger, Hixson, TN (US); Henry M. Hund JR., Cedar Bluff, AL (US); Mark A. Keller, Valley Head, AL (US)

Correspondence Address: David J. Hill;Chambliss, Bahner & Stophel, P.C., Two Union Square, 1000 Tallan Building, Chattanooga, TN, 37402, US

(21) Appl. No.: 10/759,568

(22) Filed: Jan. 20, 2004

(51) Int. Cl. B60P 1/00

(52) U.S. Cl. 414/525.2

(57) ABSTRACT

A body for a refuse collection vehicle includes a frame on which are mounted a hopper compartment and an adjacent storage compartment. The hopper compartment has a pair of opposing sidewalls, a closed forward end, an open rear end and a hopper compartment floor at a first level. The storage compartment also has a forward end that opens into the hopper compartment, a rear end having a tailgate mounted thereon, and a storage compartment floor at a second level. The second level is raised above, or at an elevation higher than, the first level. The refuse collection vehicle body also includes a transition floor between the hopper compartment floor at the first level and the storage compartment floor at the second level, and a crusher panel that is adapted to apply a downwardly directed compressive force to refuse material in the hopper compartment and to sweep said refuse material from the hopper compartment into the storage compartment. The vehicle body also includes means for removing refuse material from the storage compartment.

### FIELD OF THE INVENTION

This invention relates generally to refuse collection vehicles that include a hopper compartment for receipt of refuse and an adjacent storage compartment. More particularly, the invention relates to a drop frame type refuse collection vehicle, one which includes a hopper compartment having a hopper floor that is located at a level below that of the floor of the adjacent storage compartment. The invention also relates to mechanisms for moving refuse material from the hopper compartment into the adjacent storage compartment. A preferred embodiment of the invention also relates to mechanisms for removing refuse material from the storage compartment.

### BACKGROUND AND DESCRIPTION OF THE PRIOR ART

Refuse collection vehicles that are employed to collect refuse (including recyclable materials) are well-known. Some types of refuse collection vehicles are rear-loading, in which the tailgate assembly includes a hopper compartment, and a packer mechanism is adapted to move refuse deposited in the hopper compartment into an adjacent storage compartment. Other types of refuse collection vehicles are front-loading or side-loading, and such vehicles will generally include a hopper compartment which is mounted in front of an adjacent storage compartment. Such vehicles may also include a container lifting assembly which engages and lifts a container into a dumping position over the hopper compartment of the vehicle. The lifting assembly may be mounted on the front of the vehicle or on the side of the vehicle. Many of these vehicles include a mechanism for moving refuse material from the hopper compartment into the storage compartment and a mechanism for removing refuse material from the storage compartment. Regardless of whether they are of the front-loading, side-loading or rear-loading type, refuse collection vehicles must generally include a means or mechanism for moving refuse material from the hopper compartment into the storage compartment and a means or mechanism for removing refuse material from the storage compartment. Frequently, a packer mechanism is used to push refuse from the hopper compartment into an adjacent storage compartment. Such mechanism may also be used to compact the refuse in the storage compartment, and it may also be used to eject the compacted refuse from the vehicle. Such a packer mechanism is generally located within the hopper compartment and includes a flat, angular or curved face plate to which a hydraulic cylinder or other force-applying mechanism is attached so that the face plate may be extended to push the refuse into the adjacent storage compartment and compact it. In some cases, the face plate may be further extended by the force-applying mechanism when desired to eject the compacted refuse from the vehicle. In other cases, a hoist mechanism may be provided to raise the front end of the storage compartment above the rear end to allow compacted refuse to slide out along the angled storage compartment floor.

In most refuse collection vehicles, the supporting wheels of the vehicle frame require that the floor level of the hopper and/or storage compartments be located generally above the axles for the supporting wheels and most often above the wheels themselves. It is known, however, to provide a refuse collection vehicle in which the supporting wheels of the vehicle frame are located behind the hopper compartment and beneath the storage compartment, and the floor level for the hopper compartment is located below that of the adjacent storage compartment in order to make it easier for an operator to load refuse into the hopper compartment. Such vehicles may be known as “drop frame” vehicles. In drop frame vehicles, there is usually provided a sloped transition floor joining the lower floor of the hopper compartment with the higher floor of the storage compartment, a mechanism for moving refuse material from the bottom of the hopper compartment to and along the transition floor and into the storage compartment, and a hoist mechanism for raising the front end of the storage compartment above the rear end to remove refuse material therefrom. Collection vehicles having these features are described in U.S. Pat. No. 2,487,411 of Balbi, U.S. Pat. No. 2,961,105 and U.S. Pat. No. 3,211,309 both of Shubin and U.S. Pat. No. 3,231,111 of Clar.

Another type of drop frame refuse collection vehicle is described in U.S. Pat. No. 4,096,956 of Gaskin and U.S. Pat. No. 4,260,316 of Gollnick. These refuse collection vehicles include a mechanism for moving refuse material from the hopper compartment into the storage compartment and a mechanism for compacting the refuse material in the storage compartment and for removal of the refuse material from the storage compartment by ejecting it out the rear end thereof.

It is common for refuse that is deposited into a collection vehicle to include plastic bottles and other items of relatively high volume and low density. U.S. Pat. No. 5,029,522 of Brisson describes a collection vehicle for refuse materials which includes a component for separately handling containers such as plastic bottles that may be recycled. This recycling component is mounted behind the cab of the vehicle and oriented so that recyclable materials are moved through an inlet opening on one side of the vehicle across the width of the vehicle to an outlet door on the other side. The recycling component includes an inlet hopper and a payload chamber in which the containers are compacted prior to being discharged through the outlet door.

None of the known refuse collection vehicles which are equipped with a hopper compartment having a floor at a lower level than that of the adjacent storage compartment include a mechanism for compressing refuse materials in the hopper compartment of the collection vehicle and for removing the refuse materials from the hopper compartment into the storage compartment. It would be advantageous if a refuse collection vehicle could be provided with a body including such a mechanism.

### ADVANTAGES OF THE INVENTION

Among the advantages of the invention is that it provides a body for a refuse collection vehicle which includes a hopper compartment having a floor level below that of an adjacent storage compartment and a mechanism for compacting refuse material in the hopper compartment. The invention thus permits efficient handling of refuse material in a vehicle body of a drop frame type. Another advantage of the invention is that it permits the use of the same hopper and storage compartment construction on several types of refuse collection vehicles.

Additional advantages of this invention will become apparent from an examination of the drawings and the ensuing description.

### EXPLANATION OF TECHNICAL TERMS

As used herein, the term “hopper compartment” refers to that portion of a refuse collection vehicle into which refuse may be deposited.

As used herein, the term “storage compartment” refers to that portion of a refuse collection vehicle into which refuse may be moved from the hopper compartment.

As used herein, the terms “front”, “forward” and similar terms, when used in reference to a vehicle or to a compartment that is mounted on a vehicle, refer to the direction towards the end of the vehicle where the cab is located. When used in reference to a hopper compartment or a storage compartment that is mounted on a vehicle, the terms “front end” and “forward end” refer to the end of the compartment nearest the end of the vehicle where the cab is located.

As used herein, the term “rear” and similar terms, when used in reference to a vehicle or to a compartment that is mounted on a vehicle, refer to the direction opposite the end of the vehicle where the cab is located. A tailgate may be mounted on the rear end of a vehicle. When used in reference to a hopper compartment or a storage compartment that is mounted on a vehicle having a tailgate, the term “rear end” refers to the end of the compartment nearest the end of the vehicle where the tailgate is located.

### SUMMARY OF THE INVENTION

The invention comprises a body for a refuse collection vehicle having a frame on which are mounted a hopper compartment and an adjacent storage compartment. The hopper compartment has a pair of opposing sidewalls defining a hopper compartment width, a closed forward end, an open rear end and a hopper compartment floor at a first level. The storage compartment has a pair of opposing sidewalls defining a storage compartment width, a forward end that opens into the hopper compartment, a rear end having a tailgate mounted thereon, and a storage compartment floor at a second level. The second level is raised above, or at an elevation higher than, the first level. The refuse collection vehicle body also includes a transition floor between the hopper compartment floor at the first level and the storage compartment floor at the second level, and a crusher panel that is adapted to apply a downwardly directed compressive force to refuse material in the hopper compartment and to sweep said refuse material from the hopper compartment into the storage compartment. The vehicle body also includes means for removing refuse material from the storage compartment.

In order to facilitate an understanding of the invention, the preferred embodiments of the invention are illustrated in the drawings, and a detailed description thereof follows. It is not intended, however, that the invention be limited to the particular embodiments described or to use in connection with the apparatus illustrated herein. Various modifications and alternative embodiments such as would ordinarily occur to one skilled in the art to which the invention relates are also contemplated and included within the scope of the invention described and claimed herein.

### BRIEF DESCRIPTION OF THE DRAWINGS

The presently preferred embodiments of the invention are illustrated in the accompanying drawings, in which like reference numerals represent like parts throughout, and in which:

FIG. 1 is a front perspective view of a vehicle to which a first embodiment of the invention is mounted.

FIG. 2 is a top view of the vehicle of FIG. 1.

FIG. 3A is an exploded perspective view of a portion of a preferred packer assembly that is a part of a preferred embodiment of the invention.

FIG. 3B is a top view of a portion of the preferred packer assembly of FIG. 3A with the top plate removed for clarity.

FIG. 4 is a perspective view of the preferred packer assembly of FIGS. 3A and 3B in a retracted position in a hopper compartment.

FIG. 5 is a perspective view of the preferred packer assembly of FIGS. 3A, 3B and 4 in an extended position in a hopper compartment.

FIG. 6A is a partial sectional view through the hopper and storage compartment of a vehicle body comprising a preferred embodiment of the invention, showing the preferred crusher panel in a preferred first orientation at the beginning of its preferred rotation cycle.

FIG. 6B is a partial sectional view through the hopper and storage compartment of a vehicle body comprising a preferred embodiment of the invention, showing the preferred crusher panel in a first intermediate position of rotation.

FIG. 6C is a partial sectional view through the hopper and storage compartment of a vehicle body comprising a preferred embodiment of the invention, showing the preferred crusher panel in a second intermediate position of rotation.

FIG. 6D is a partial sectional view through the hopper and storage compartment of a vehicle body comprising a preferred embodiment of the invention, showing the preferred crusher panel in a third intermediate position of rotation.

FIG. 6E is a partial perspective view of a portion of the crusher panel of FIG. 6D, showing details of a preferred attachment mechanism for attaching one end of a crusher panel actuator to the crusher panel.

FIG. 6F is a partial sectional view through the hopper and storage compartment of a vehicle body comprising a preferred embodiment of the invention, showing the preferred crusher panel in a fourth intermediate position of rotation.

FIG. 6G is a partial sectional view through the hopper and storage compartment of a vehicle body comprising a preferred embodiment of the invention, showing the preferred crusher panel in a fifth intermediate position of rotation.

FIG. 6H is a partial sectional view through the hopper and storage compartment of a vehicle body comprising a preferred embodiment of the invention, showing the preferred crusher panel in a sixth intermediate position of rotation.

FIG. 6I is a partial sectional view through the hopper and storage compartment of a vehicle body comprising a preferred embodiment of the invention, showing the preferred crusher panel in a seventh intermediate position of rotation.

FIG. 6J is a partial sectional view through the hopper and storage compartment of a vehicle body comprising a preferred embodiment of the invention, showing the preferred crusher panel in a preferred second orientation at the end of its preferred rotation cycle.

FIG. 6K is a partial perspective view of the preferred crusher panel in the preferred second orientation shown in FIG. 6J.

FIG. 7A is a partial sectional view through the hopper and storage compartment of a vehicle body comprising a preferred embodiment of the invention, showing the preferred ejector panel in a preferred retracted position at the beginning of its preferred pivot cycle.

FIG. 7B is a partial sectional view through the hopper and storage compartment of a vehicle body comprising a preferred embodiment of the invention, showing the preferred ejector panel in a first intermediate position of pivotal movement.

FIG. 7C is a partial sectional view through the hopper and storage compartment of a vehicle body comprising a preferred embodiment of the invention, showing the preferred ejector panel in a second intermediate position of pivotal movement.

FIG. 7D is a partial sectional view through the hopper and storage compartment of a vehicle body comprising a preferred embodiment of the invention, showing the preferred ejector panel in a third intermediate position of pivotal movement.

FIG. 7E is a partial sectional view through the hopper and storage compartment of a vehicle body comprising a preferred embodiment of the invention, showing the preferred ejector panel in a fourth intermediate position of pivotal movement.

FIG. 7F is a partial sectional view through the hopper and storage compartment of a vehicle body comprising a preferred embodiment of the invention, showing the preferred ejector panel in a preferred extended position at the end of its preferred pivot cycle.

FIG. 8 is a partial perspective view of the preferred ejector panel of the invention.

FIG. 9 is a partial perspective view of the preferred ejector panel and ejector guide frame assembly of the invention.

FIG. 10 is a partial perspective view of the preferred ejector guide frame assembly showing a portion of the preferred ejector slide lock.

FIG. 11 is a partial perspective view of a portion of the preferred ejector panel and certain of the components of the over center lock.

FIG. 12 is a partial perspective view of a portion of the preferred ejector guide frame assembly showing a portion of the preferred ejector slide lock in a locked configuration in which the ejector guide frame is locked to the ejector guide track when the upper end of the preferred ejector panel is at a preferred forward position.

FIG. 13 is a side view of a portion of the ejector panel and ejector guide frame, showing the components of the preferred ejector slide lock.

FIG. 14 is a side view of the components of an ejector cylinder drift lock that is a part of a preferred embodiment of the invention.

FIG. 15 is a sectional view through the preferred air cylinder of the ejector cylinder drift of FIG. 14.

FIG. 16 is schematic view illustrating the manner of operation of the ejector cylinder drift lock of FIGS. 14 and 15.

FIG. 17 is a side view of a vehicle to which a second embodiment of the invention is mounted.

### DESCRIPTION OF THE PREFERRED EMBODIMENTS OF THE INVENTION

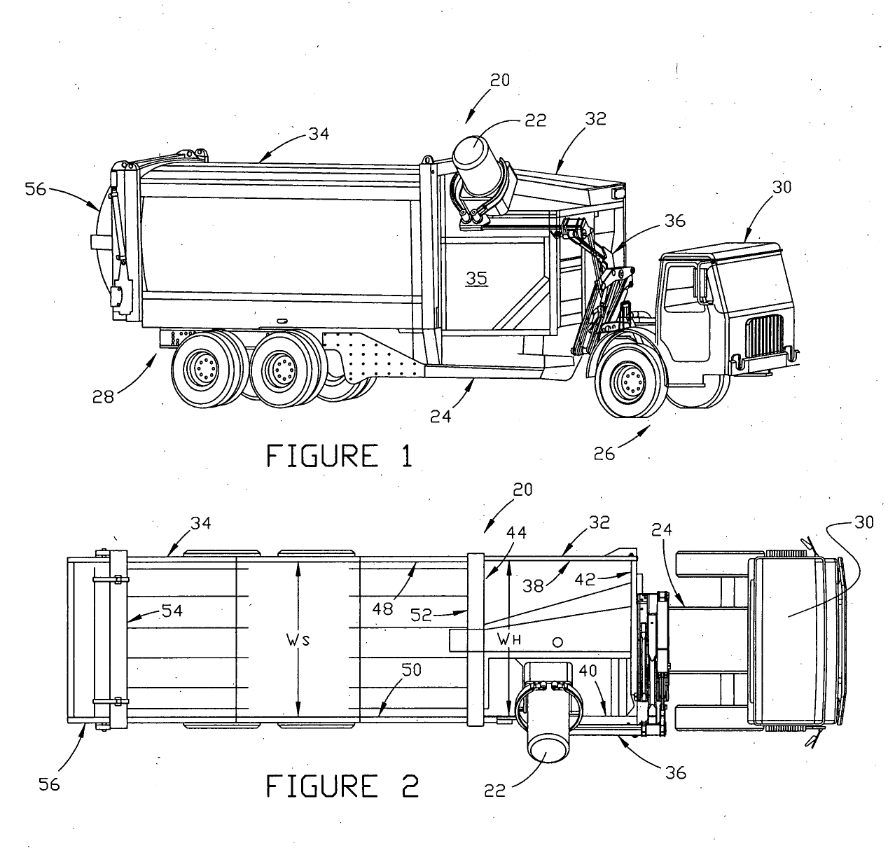

As shown in FIGS. 1 and 2, the invention comprises a body 20 for a refuse collection vehicle which may be used to collect trash and refuse from containers such as container 22 that are placed curbside (or at another convenient location) in a residential area. The body is mounted on vehicle frame 24, which has a front end 26 and a rear end 28, an operator's cab 30 at the front end, an engine behind the cab (not shown) and a drive train (also not shown) which is adapted to drive the vehicle across a roadway. Body 20 is comprised of hopper compartment 32, which is mounted on the frame, and storage compartment 34, which is mounted on the frame adjacent to and to the rear of the hopper compartment. The hopper compartment is provided for deposit of refuse material, manually through a side door 35 and/or automatically by means of a container lifting assembly such as the DuraPack™ automated frontloader, the Formula 7000® automated sideloader, the Rapid Rail® automated sideloader, or the Python® automated sideloader, all of which are sold by Heil Environmental Industries, Ltd. of Chattanooga, Tenn. Preferably, a container lifting assembly 36 such as the Python® automated sideloader (which is described in copending U.S. patent application Ser. No. 09/975,759), is attached (by welding, bolting or other suitable means) to the frame in front of hopper compartment 32 and behind operator's cab 30.

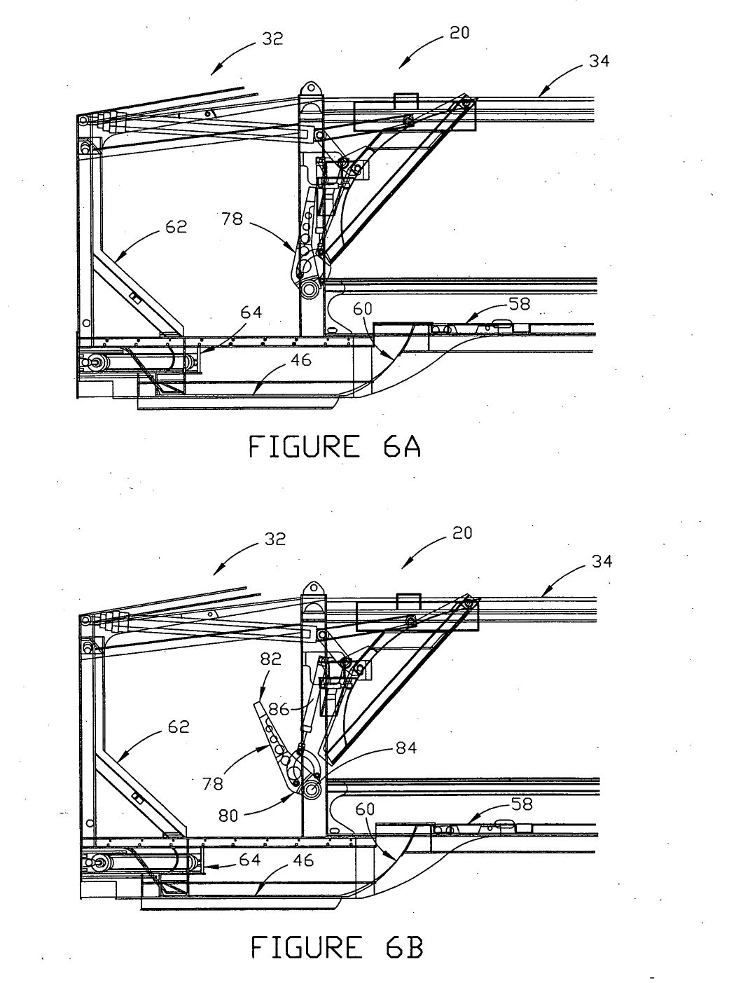

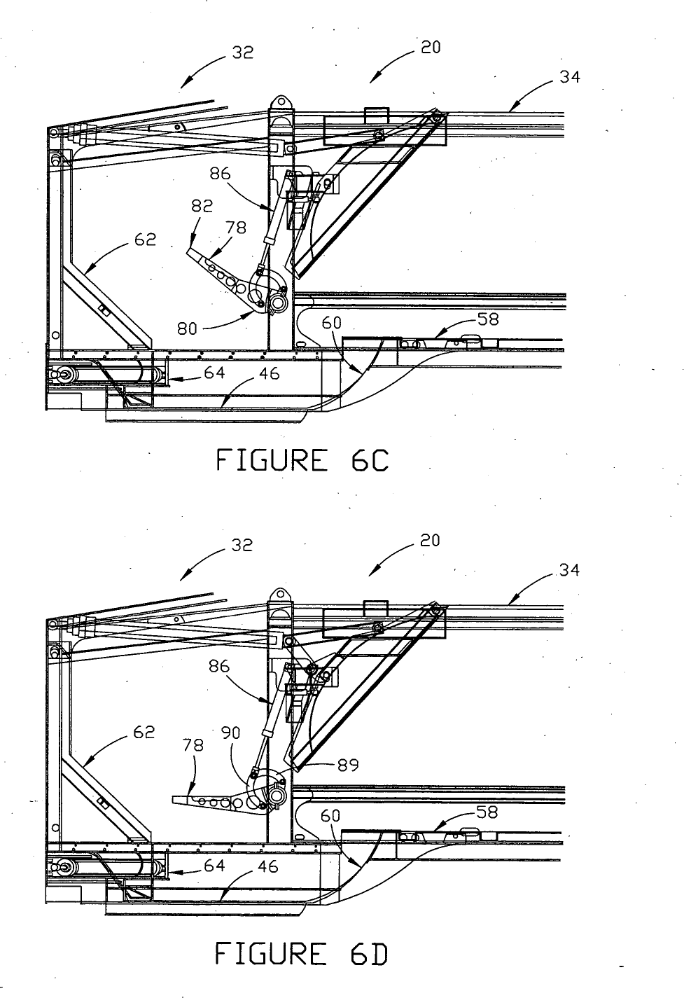

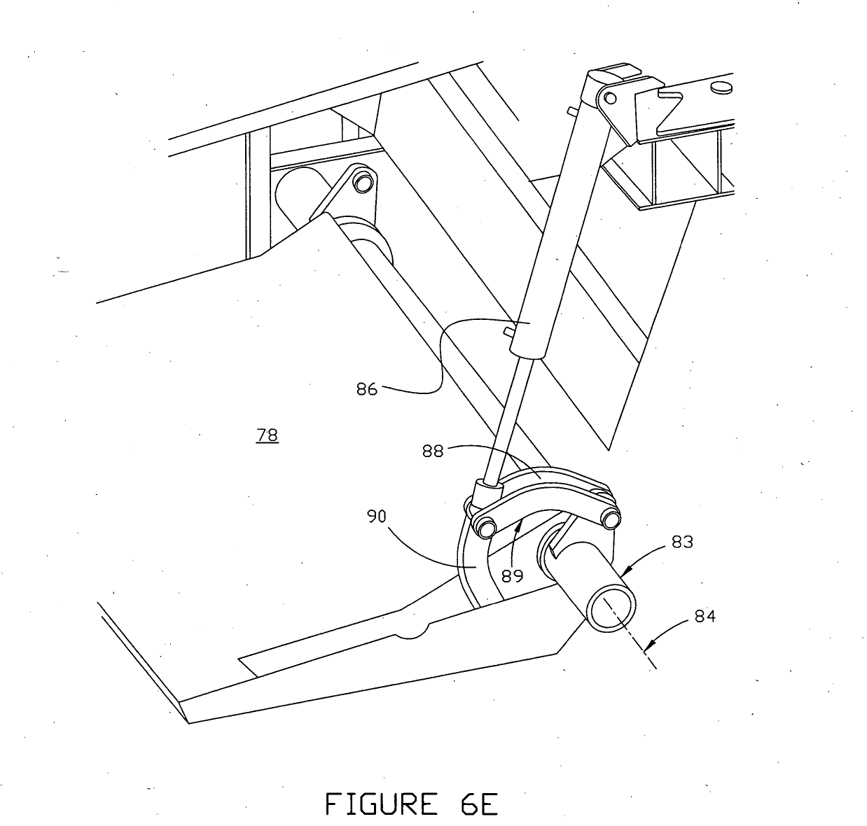

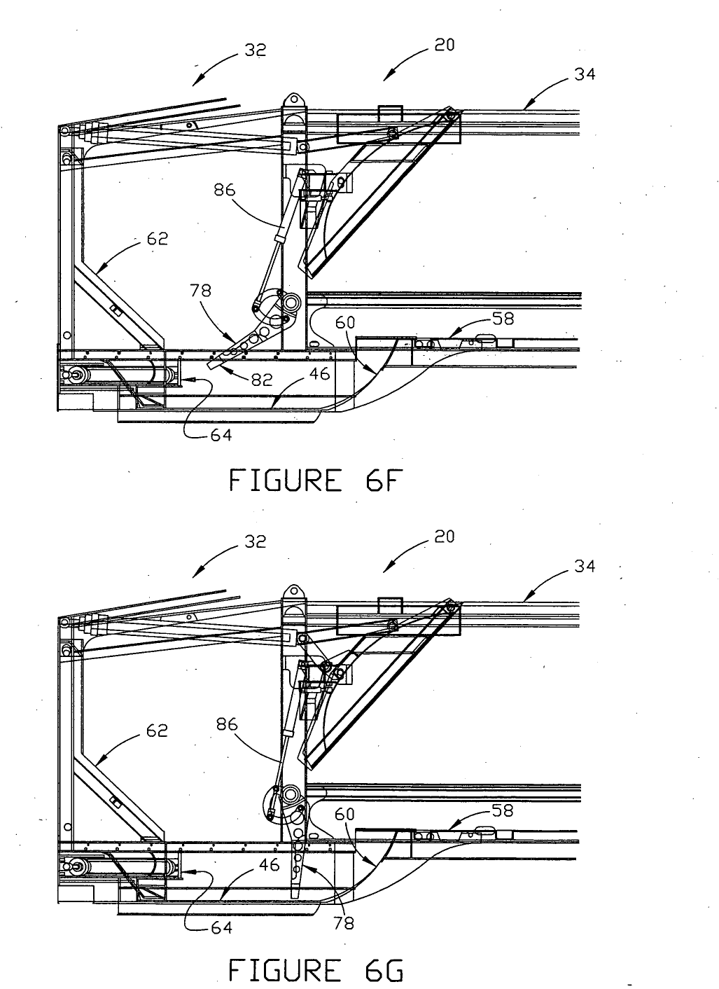

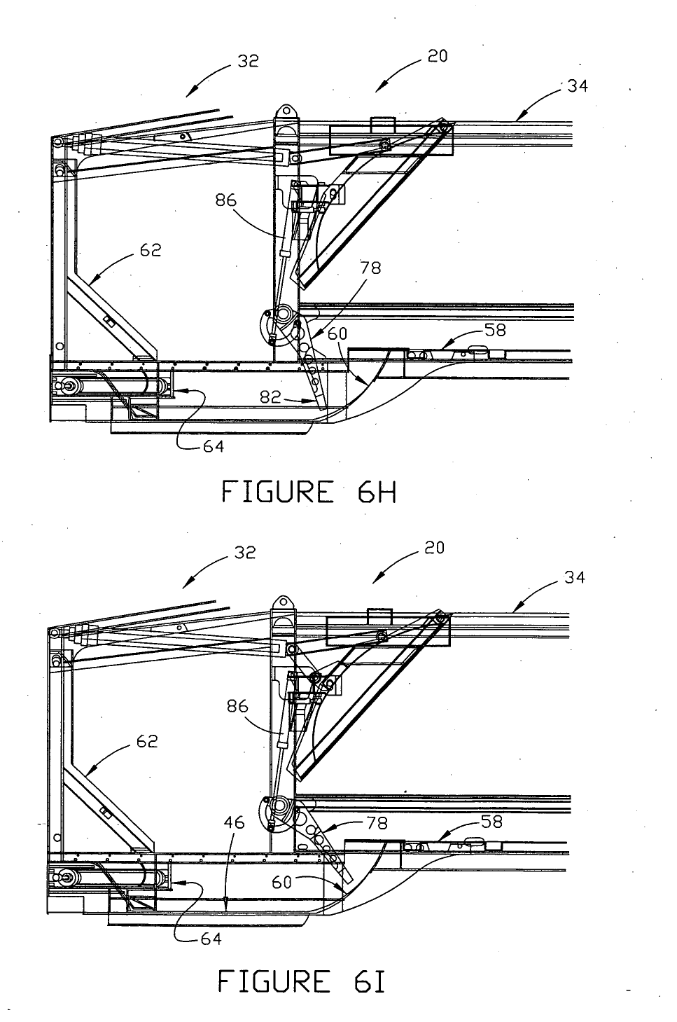

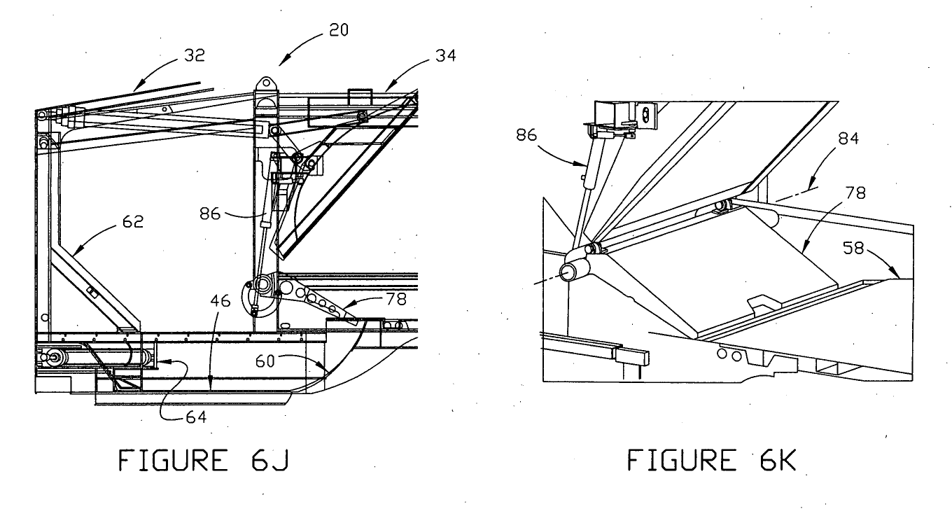

As shown in FIGS. 2 and 6A-6K, hopper compartment 32 includes a pair of opposing sidewalls 38 and 40 defining a hopper compartment width W_{H}, a closed forward end 42, an open rear end 44 and a hopper compartment floor 46 at a first level. Storage compartment 34 has a pair of opposing sidewalls 48 and 50 defining a storage compartment width W_{S}, said storage compartment width preferably being no less than the hopper compartment width. Storage compartment 34 also has a forward end 52 that opens into the hopper compartment, a rear end 54 having a tailgate 56 mounted thereon and a storage compartment floor 58 at a second level. As shown in FIGS. 6A-6K, the second level of storage compartment floor 58 is raised above the first level of hopper compartment floor 46. Body 20 also includes a transition floor 60 between hopper compartment floor 46 at the first level and storage compartment floor 58 at the second level.

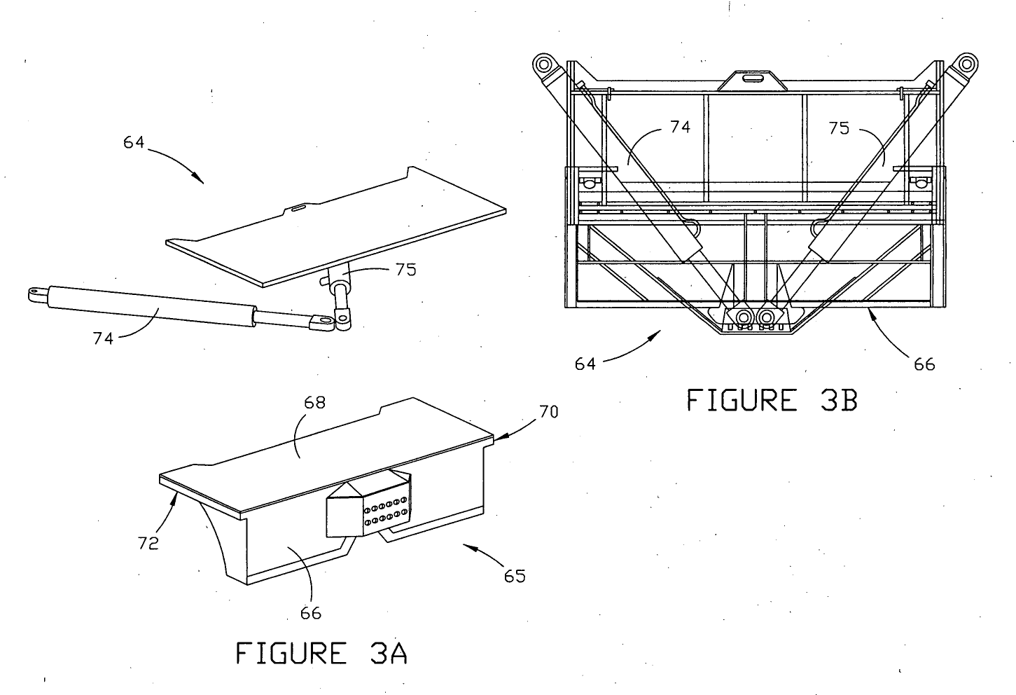

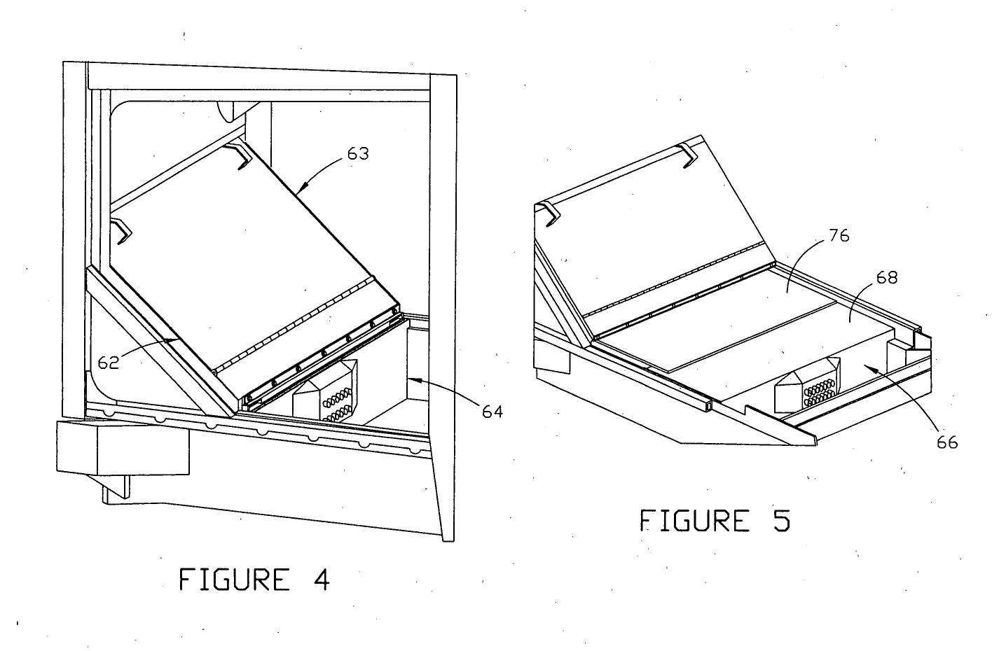

Referring now to FIGS. 3A-5, preferred hopper compartment 32 includes a pair of sloped side supports (only one of which, support 62, is shown in the drawings) at its forward end. In this embodiment of the invention, an upper panel 63 is mounted atop the side supports, and a reciprocating packer assembly 64 is mounted beneath the upper panel. Packer assembly 64 is adapted to move refuse from the forward end of the hopper compartment towards the rear end of the hopper compartment. Preferred assembly 64 includes a packer panel 65 having a rearwardly facing plate 66 and a top plate 68 which includes a pair of guides 70 and 72 that slidingly engage corresponding grooves in the sidewalls of the hopper compartment. A fluid-operated actuator, or more preferably, a pair of such actuators 74 and 75 are mounted to packer panel 65 beneath upper panel 63 to move the packer panel between a retracted position (shown in FIG. 4) and an extended position (shown in FIG. 5). Preferably, top plate 68 of packer assembly 64 is attached to a follower panel or spill shield 76 that rests on top of the sloped side supports and beneath the upper panel when the packer panel is in the retracted position. The follower panel slides out from beneath upper panel 63 as the packer panel is extended and slides back underneath the upper panel as the packer panel is retracted. The upper panel and follower panel protect the actuators from refuse that is deposited into the hopper compartment, and the sloped orientation of upper panel 63 allows refuse material that falls on this panel to slide off behind plate 66 of the packer assembly.

As shown in FIGS. 6A-6K, preferred body 20 includes a crusher panel 78 that is mounted between the sidewalls of the hopper compartment and adjacent to the rear end thereof. The crusher panel is adapted to apply a downwardly directed compressive force to refuse material in the hopper compartment and to sweep said refuse material from the hopper compartment into the storage compartment. Crusher panel 78 has a pivot end 80 and a sweep end 82, and is pivotally mounted at its pivot end between the sidewalls of the hopper compartment and adjacent to the rear end thereof, preferably on header tube 83 (FIG. 6E). This attachment of the crusher panel permits the crusher panel to be pivoted about crusher pivot axis 84 (through the center of preferred header tube 83) between a first orientation in which the sweep end is generally disposed above the pivot end (preferably, in the orientation illustrated in FIG. 6A) and a second orientation in which the sweep end is adjacent to the storage compartment floor (preferably, in the orientation illustrated in FIGS. 6J and 6K). Preferably, transition floor 60 is curved so that sweep end 82 of the crusher panel sweeps along near the transition floor to push refuse material up the curved transition floor and into the storage compartment. As shown by comparing FIG. 6G with FIGS. 6H-6J, it is also preferred that transition floor 60 diverges away from the sweep end of the crusher panel as the crusher panel approaches the storage compartment floor. This divergence of the transition floor will serve to prevent refuse material from being wedged between the sweep end of crusher panel 78 and the transition floor as the material is moved up the transition floor towards the storage compartment.

The preferred crusher panel assembly also includes means for pivoting the crusher panel about the crusher pivot axis between the first orientation and the second orientation to apply a downwardly directed compressive force to refuse material in the hopper compartment, and to sweep the refuse material from the hopper compartment into the storage compartment. Preferably, this means for pivoting the crusher panel about the crusher pivot axis comprises a fluid-operated crusher panel actuator 86 and an attachment mechanism for attaching one end of the crusher panel actuator to the crusher panel. As best shown in FIG. 6E, this preferred attachment mechanism includes a linkage system comprised of a pair of curved upper links 88 and 89, and a lower link 90 that, in cooperation with actuator 86, permit the crusher panel to pivot between the first orientation and the second orientation through an arc of about 250°.

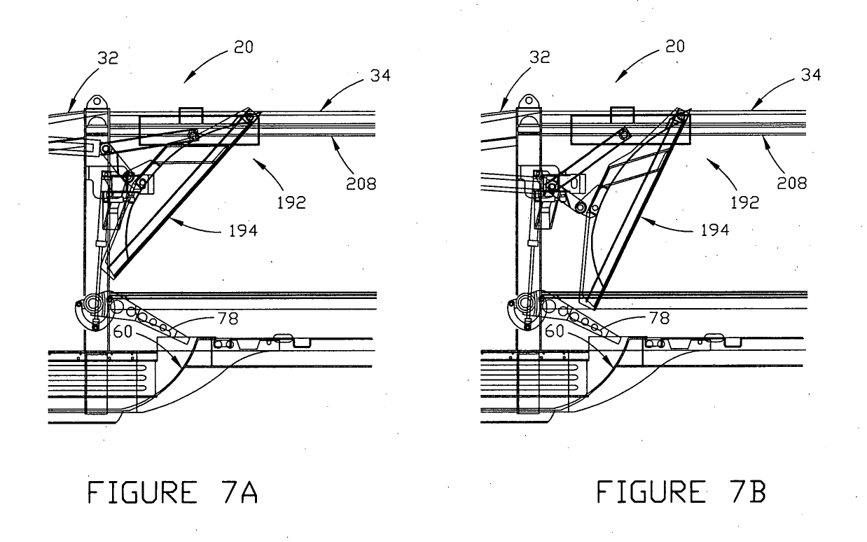

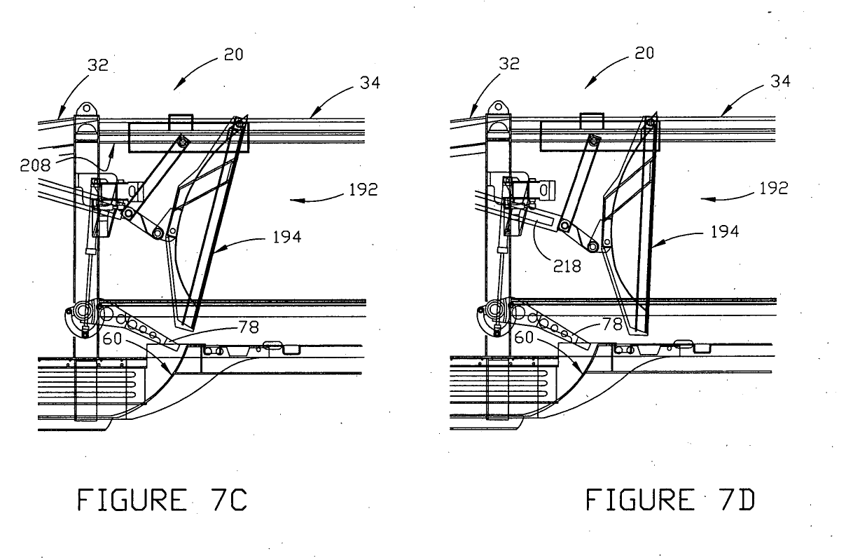

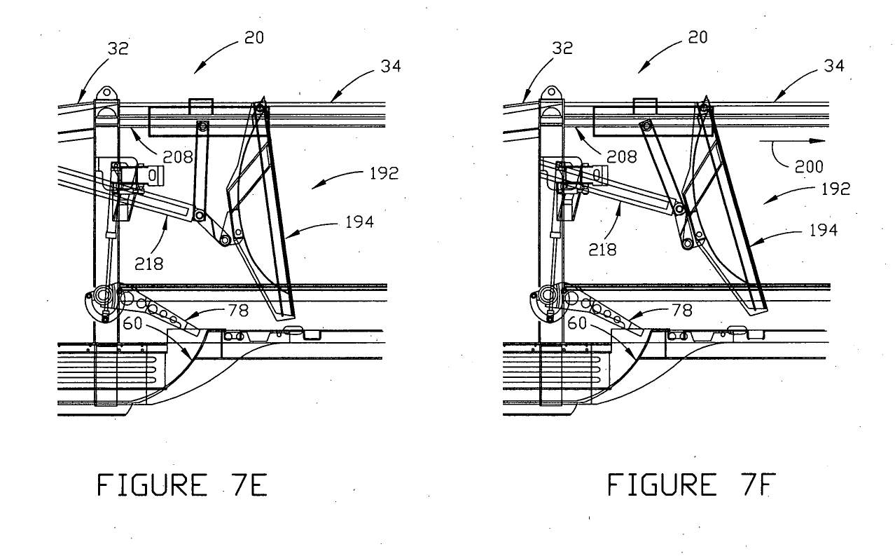

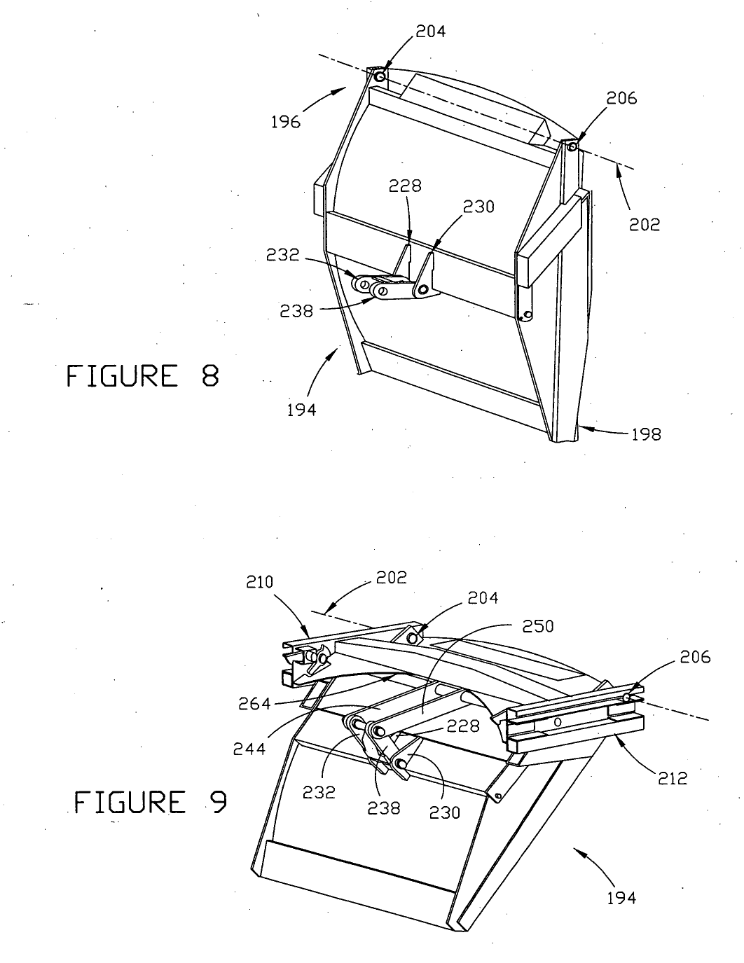

The vehicle body also includes means for removing refuse material from the storage compartment. One such means is the preferred ejector mechanism illustrated in FIGS. 7A-16. As shown therein, vehicle body 20 includes hopper compartment 32, adjacent storage compartment 34 and crusher panel 78. Body 20 also includes preferred ejector mechanism 192 which includes ejector panel 194 having an upper end 196 and a lower end 198 (see FIG. 8). The upper end is mounted between the sidewalls of the storage compartment for axial movement between a forward position.(illustrated in FIGS. 7A-7F) and a rear position (indicated by arrow 200 in FIG. 7F) to which the panel may be moved to remove or eject refuse material from the storage compartment through an open tailgate.

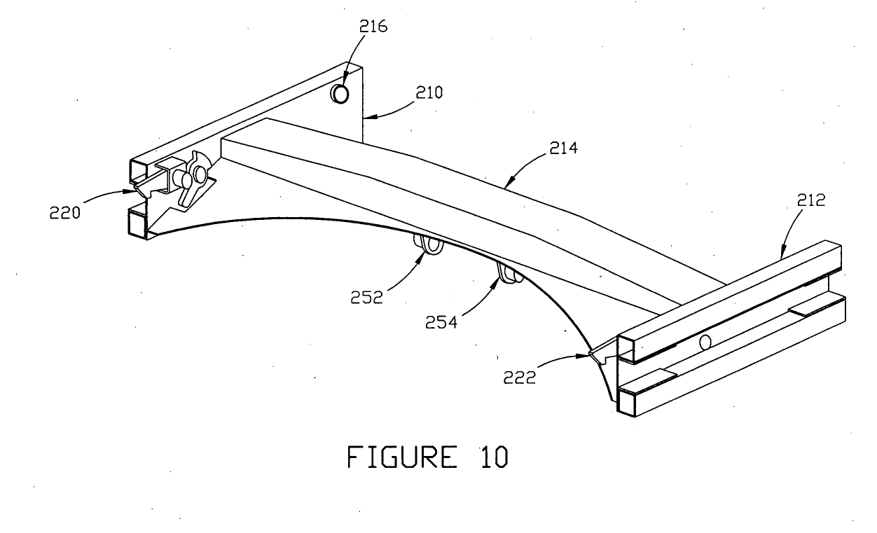

Preferably, ejector panel 194 is pivotally mounted about an ejector pivot axis 202 (best shown in FIGS. 8 and 9) on a pair of pivot pins 204 and 206 at upper end 196 for pivotal movement between a retracted orientation in which lower end 198 is disposed adjacent to the pivot end of the crusher panel when the ejector panel is in the forward position (preferably, in the orientation illustrated in FIG. 7A) and an extended orientation in which the lower end 198 is disposed rearwardly from the retracted position (preferably, in the orientation illustrated in FIG. 7F). Preferred ejector mechanism 192 also includes a pair of ejector guide tracks (only one of which, guide track 208, is shown in the drawings) which are mounted opposite each other and disposed axially on the opposing sidewalls of the storage compartment. An ejector guide frame assembly comprised of a pair of ejector guide frames 210 and 212 which are joined by guide frame support 214 (best shown in FIG. 10), is adapted to move along the ejector tracks as the upper end of the ejector panel is moved axially between the forward position and the rear position (in a manner to be described hereinafter). Each guide frame of the guide frame assembly includes a pin socket (only one of which, socket 216, is shown in FIG. 10) within which a pivot pin will pivot as the ejector panel is pivoted between the retracted orientation and the extended orientation.

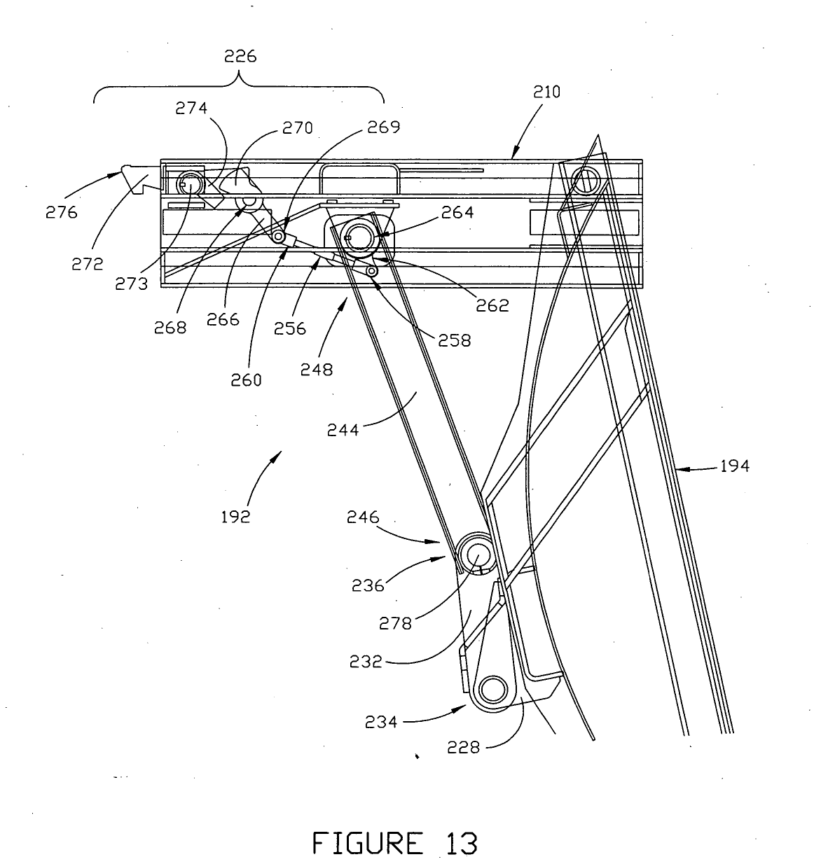

In the preferred embodiment of the invention illustrated in the drawings, the ejector mechanism includes an ejector actuator 218 that is located and arranged to pivot the ejector panel about the ejector pivot axis between the retracted orientation and the extended orientation, and to move the upper end of the ejector panel between the forward position and the rear position. Preferably, as shown in FIGS. 7A-7F, crusher panel 78 and ejector panel 194 are located and arranged so that pivoting of the ejector panel from the retracted orientation to the extended orientation while the crusher panel is in the second orientation will sweep the lower end of the ejector panel across the crusher panel. In this preferred embodiment of the invention, the ejector mechanism includes a pair of ejector slide locks 220 and 222 that are located and arranged on the ejector guide frames near the open end of the storage compartment so as to releasably lock the ejector guide frame assembly to the ejector guide tracks when the upper end of the ejector panel is at the forward position. Each ejector slide lock is associated with one of the ejector guide frames. Thus, as shown in FIG. 12, ejector slide lock 220 is associated with ejector guide frame 210 and is adapted to engage guide stop 224 of track 208. Each ejector slide lock includes a linkage system (such as linkage system 226 of ejector slide lock 220 that is best illustrated in FIG. 13) that is mounted, arranged and configured so that when the ejector actuator has pivoted the ejector panel from the retracted orientation to the extended orientation, the slide lock will disengage so that the ejector panel may be moved from the forward position towards the rear position. As shown in FIG. 13, the preferred ejector guide frame assembly includes a pair of base brackets 228 and 230 mounted on the forward side of the ejector panel. A pair of base links 232 and 238, each having a first end and a second end (first end 234 and second end 236 of base link 232 are shown in FIG. 13), are pivotally mounted at their first ends on the base brackets 228 and 230. A pair of support links 244 and 250, each having a first end and a second end (first end 246- and second end 248 of support link 244 are shown in FIG. 13), are pivotally mounted at their first ends to the second ends of the base links, and are pivotally mounted at their second ends on support brackets 252 and 254 respectively of guide frame support 214. An intermediate link is provided for each ejector slide lock (only one of which, intermediate link 256, is shown in the drawings).

As shown in FIG. 13, intermediate link 256 has first end 258 and second end 260. First end 258 of intermediate link 256 is pivotally attached to tail portion 262 of transfer rod 264 (which transfers pivotal motion from support link 244 to intermediate link 256). A release link is provided for each ejector slide lock (only one of which, release link 266, is shown in the drawings). Release link 266 is pivotally attached at pivot 268 to ejector guide frame 210. Release link 266 has a base end 269 and a catch engagement end 270. Base end 269 of release link 266 is pivotally attached to second end 260 of intermediate link 256. A catch link 272 is provided for each ejector slide lock (one of which is shown in FIG. 13). Catch link 272 is pivotally mounted at pivot 273 to ejector guide frame 210 and has a base end 274 that is adapted to engage catch engagement end 270 of release link 266, and a catch end 276 that is adapted to engage an ejector guide stop.

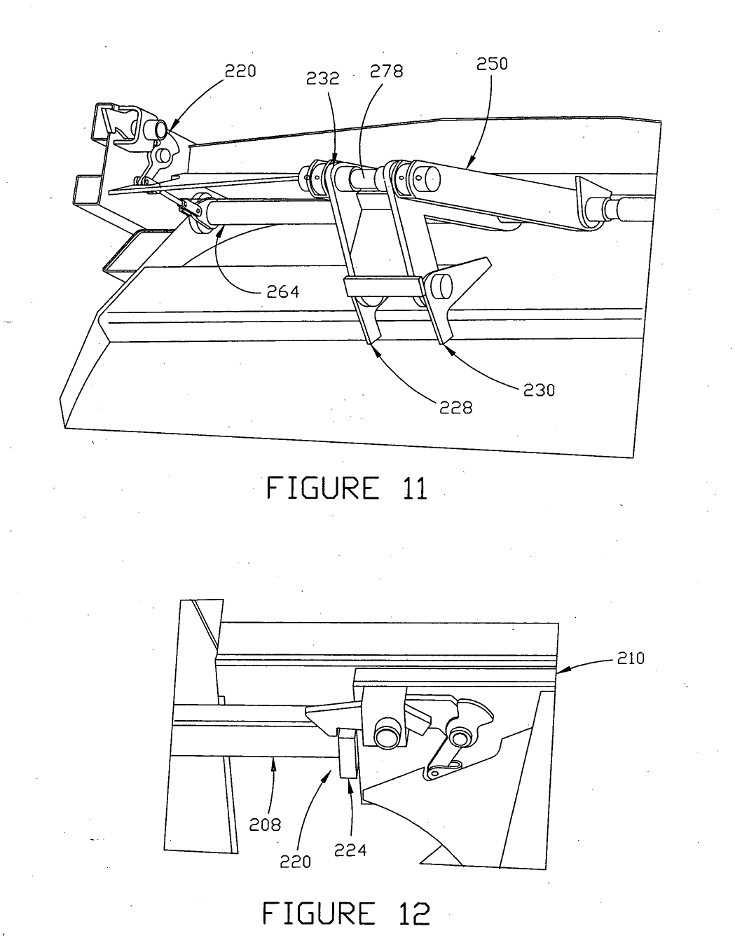

Preferred ejector actuator 218 is pivotally attached to the ejector panel at pin 278 (best shown in FIG. 11) between links 232 and 238. As can be appreciated from an examination of the drawings, the components of the preferred ejector slide lock and the ejector actuator are mounted, arranged and configured so that the ejector actuator pivots the ejector panel from the retracted position (preferably the position illustrated in FIG. 7A) to the extended position (preferably the position illustrated in FIG. 7F) with the catch link engaged with the ejector guide stop. As the ejector panel is pivoted to the extended position, the catch link will disengage from the ejector guide stop so that further extension of the ejector actuator will move the ejector panel from the forward position towards the rear position. Furthermore, the arrangement of ejector actuator 218, base brackets 228 and 230, base links 232 and 238, support links 244 and 250 and support brackets 252 and 254 of guide frame support 214 creates an over-center lock that is located and arranged to releasably lock the ejector panel in the extended orientation.

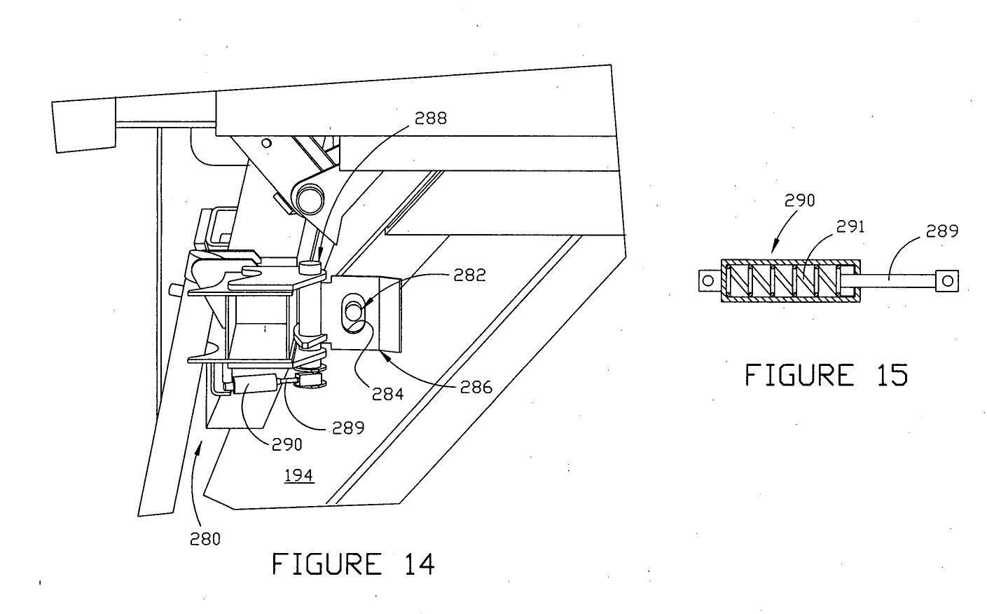

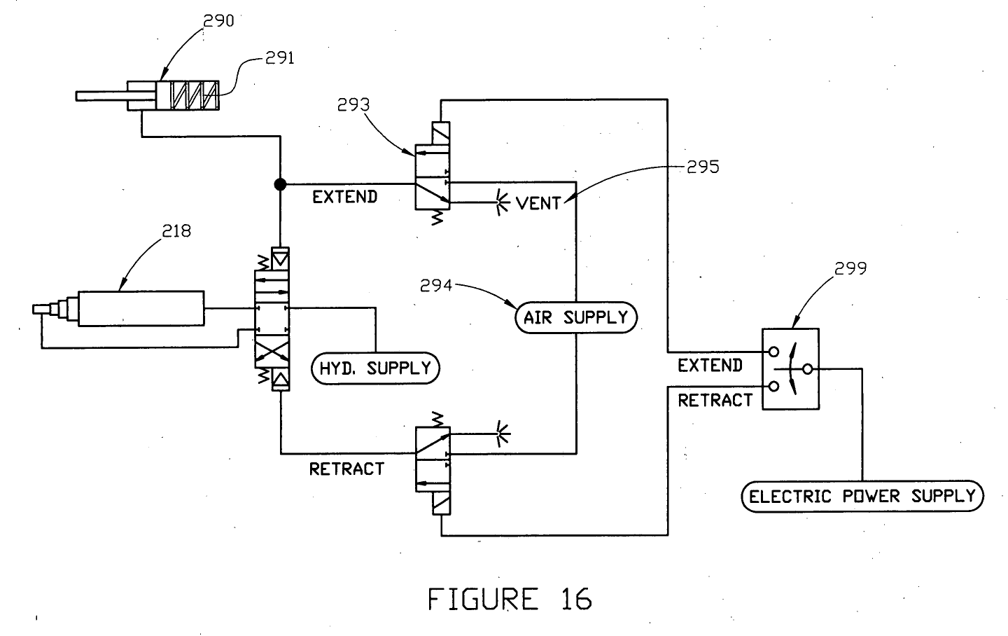

Preferred body 20 also includes an ejector cylinder drift lock 280 (shown in FIGS. 14-16) that releasably locks the ejector panel in the retracted orientation. Lock pin 282 is located on the side of ejector panel 194 and is adapted to engage with slot 284 in latch 286. Latch 286 is fixed to pivot pin 288, and piston rod 289 of air cylinder 290 is pivotally attached to pin 288. Air cylinder 290 includes spring 291 which biases piston rod 289 in the extended position. Associated with air cylinder 290, as illustrated in FIG. 16, is an air valve 293 receiving air from a source 294 located conventionally within body 20 (or the vehicle to which it is attached). Valve 293 has a vent 295 to exhaust the air back from cylinder 290 when the valve is closed. The air valve is controlled by a rocker switch 299 in the cab of the vehicle. Rocker switch 299 must be held in either the “Extend” or “Retract” position or it is biased off. When the vehicle operator places switch 299 in the “Extend” position to actuate ejector actuator 218 to pivot ejector panel 194, air valve 293 is also opened to actuate air cylinder 290 to retract piston rod 289 against the bias of spring 291 to pivot pin 288 and latch 286 to the unlocked position. The force required to actuate air cylinder 290 is less than that required to actuate ejector actuator 218. Consequently, the ejector cylinder drift lock will unlock before the ejector actuator begins to pivot the ejector panel from the retracted position (preferably the position illustrated in FIG. 7A) to the extended position (preferably the position illustrated in FIG. 7F).

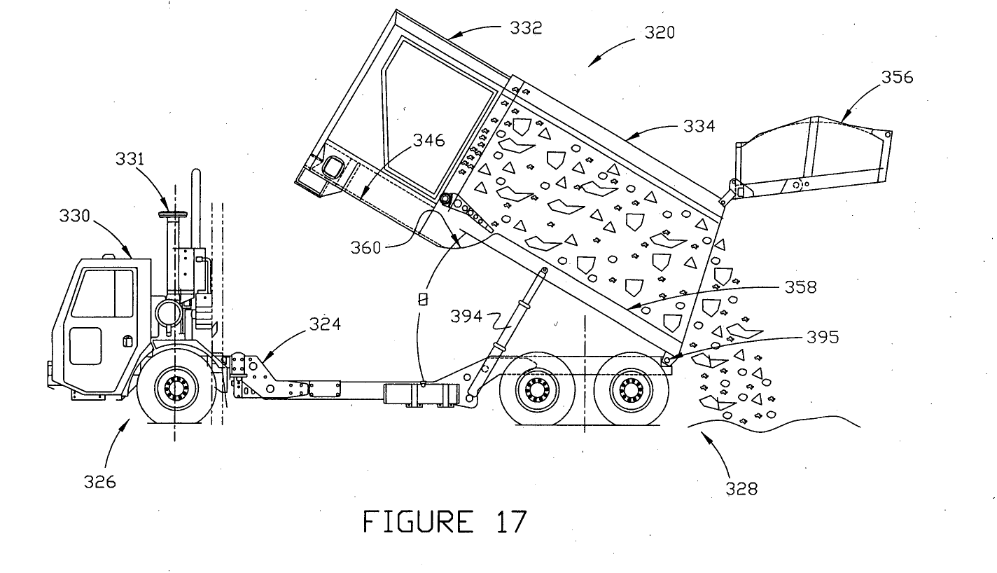

Another embodiment of the invention is illustrated in FIG. 17. As shown therein, body 320 for a refuse collection vehicle is mounted on vehicle frame 324, which has a front end 326 and a rear end 328, an operator's cab 330 at the front end, an engine 331 behind the cab and a drive train (not shown) which is adapted to drive the vehicle across a roadway. Body 320 is comprised of hopper compartment 332, which is mounted on the frame, and storage compartment 334, which is mounted on the frame adjacent to and to the rear of the hopper compartment. The hopper compartment is provided for deposit of refuse material, manually through a side door (not shown) and/or automatically by means of a container lifting assembly (also not shown). Hopper compartment 332 is similar to hopper compartment 32 of body 20. It includes a pair of opposing sidewalls defining a hopper compartment width, a closed forward end, an open rear end and a hopper compartment floor 346 at a first level. Storage compartment 334 is likewise similar to storage compartment 34 of body 20. Storage compartment 334 has a pair of opposing sidewalls defining a storage compartment width, which storage compartment width is preferably substantially equal to the hopper compartment width. Storage compartment 334 also has a forward end that opens into the hopper compartment, a rear end having a tailgate 356 mounted thereon and a storage compartment floor 358 at a second level that is above the first level of hopper compartment floor 346. Body 320 also includes a transition floor 360 between hopper compartment floor 346 at the first level and storage compartment floor 358 at the second level.

Preferably, hopper compartment 332 includes a reciprocating packer assembly in its forward end that is similar to packer assembly 64 of body 20, which packer assembly is adapted to move refuse from the forward end of the hopper compartment towards the rear end of the hopper compartment. Preferred body 320 also includes a crusher panel 378 that is mounted between the sidewalls of the hopper compartment and adjacent to the rear end thereof. The crusher panel is adapted to apply a downwardly directed compressive force to refuse material in the hopper compartment and to sweep said refuse material from the hopper compartment into the storage compartment. Crusher panel 378, which is comparable to crusher panel 78 of body 20, has a pivot end and a sweep end, and is pivotally mounted at its pivot end between the sidewalls of the hopper compartment and adjacent to the rear end thereof. This attachment of the crusher panel permits the crusher panel to be pivoted about a crusher pivot axis between a first orientation in which the sweep end is generally disposed above the pivot end (preferably, in an orientation similar to that illustrated for crusher panel 78 in FIG. 6A) and a second orientation in which the sweep end is adjacent to the storage compartment floor (preferably, in an orientation similar to that illustrated for crusher panel 78 in FIGS. 6J and 6K). Preferably, transition floor 360 is curved so that the sweep end of crusher panel 378 sweeps along near the transition floor to push refuse material up the curved transition floor and into the storage compartment. It is also preferred that transition floor 360 diverges away from the sweep end of the crusher panel as the crusher panel approaches the storage compartment floor, in order to prevent refuse material from being wedged between the sweep end of crusher panel 378 and the transition floor as the material is moved up the transition floor towards the storage compartment. Body 320 also includes means for pivoting the crusher panel about the crusher pivot axis between the first orientation and the second orientation to apply a downwardly directed compressive force to refuse material in the hopper compartment, and to sweep the refuse material from the hopper compartment into the storage compartment. Preferably, this means for pivoting the crusher panel about the crusher pivot axis comprises a fluid-operated crusher panel actuator (similar to actuator 86 of body 20) and an attachment mechanism for attaching one end of the crusher panel actuator to the crusher panel. Preferably, this attachment mechanism includes a linkage system similar to that for crusher panel 78 of body 20 which, in cooperation with the crusher panel actuator, permits the crusher panel to pivot between the first orientation and the second orientation through an arc of about 250°.

Vehicle body 320 also includes means for removing refuse material from the storage compartment in the form of hoist 394 that is adapted to raise the forward end of the storage compartment above the rear end thereof. Preferably, hoist 394 is adapted to raise the forward end of the storage compartment by pivoting the storage compartment about pivot axis 395 so that the storage compartment floor is generally disposed at an angle θ of no more than about 35° from the horizontal.

Although this description contains many specifics, these should not be construed as limiting the scope of the invention but as merely providing illustrations of some of the presently preferred embodiments thereof, as well as the best mode contemplated by the inventor of carrying out the invention. The invention, as described herein, is susceptible to various modifications and adaptations, and the same are intended to be comprehended within the meaning and range of equivalents of the appended claims.

1. A body for a refuse collection vehicle having a frame, said body comprising:
(a) a hopper compartment mounted on the frame and having:
(i) a pair of opposing sidewalls defining a hopper compartment width;
(ii) a closed forward end;
(iii) an open rear end; and
(iv) a hopper compartment floor at a first level;
(b) a storage compartment mounted on the frame adjacent to and to the rear of the hopper compartment, said storage compartment having:
(i) a pair of opposing sidewalls defining a storage compartment width;
(ii) a forward end that opens into the hopper compartment;
(iii) a rear end having a tailgate mounted thereon; and
(iv) a storage compartment floor at a second level, said second level being raised above the first level;
(c) a transition floor between the hopper compartment floor at the first level and the storage compartment floor at the second level;
(d) a crusher panel that is adapted to apply a downwardly directed compressive force to refuse material in the hopper compartment and to sweep said refuse material from the hopper compartment into the storage compartment;
(e) means for removing refuse material from the storage compartment.

2. The body of claim 1 wherein the crusher panel has a pivot end and a sweep end, said pivot end being pivotally mounted so that said crusher panel may be pivoted about a crusher pivot axis at its pivot end between a first orientation in which the sweep end is generally disposed above the pivot end and a second orientation in which the sweep end is adjacent to the storage compartment floor.

3. The body of claim 2 wherein the transition floor diverges away from the sweep end of the crusher panel as the sweep end of the crusher panel approaches the storage compartment floor during pivoting of the crusher panel.

4. The body of claim 2:
(a) wherein the crusher panel is mounted adjacent to the rear end of the hopper compartment;
(b) which includes means for pivoting the crusher panel about the crusher pivot axis between said first orientation and said second orientation to apply a downwardly directed compressive force to refuse material in the hopper compartment, and to sweep said refuse material from the hopper compartment into the storage compartment.

5. The body of claim 4 wherein the means for pivoting the crusher panel about the crusher pivot axis comprises:
(a) a crusher panel actuator; and
(b) an attachment mechanism for attaching one end of the crusher panel actuator to the crusher panel, said mechanism comprising a linkage system that permits the crusher panel to pivot between the first orientation and the second orientation through an arc of about 250°.

6. The body of claim 1 which includes a reciprocating packer that is mounted in the forward end of the hopper compartment and is adapted to move refuse from the forward end of the hopper compartment towards the rear end of the hopper compartment so that it may be compacted and swept by the crusher panel, which reciprocating packer comprises:
(a) a packer panel;
(b) an actuator that is attached to the packer panel and adapted to move the packer panel between:
(i) a retracted position which is in front of the crusher panel when said crusher panel pivots between the first orientation and the second orientation; and
(ii) an extended position which is adjacent to the transition floor.

7. The body of claim 1 wherein the means for removing refuse material from the storage compartment comprises a hoist that is adapted to raise the forward end of the storage compartment above the rear end thereof.

8. The body of claim 7 wherein the hoist is adapted to raise the forward end of the storage compartment so that the storage compartment floor is generally disposed at an angle of no more than about 35° from the horizontal.

9. The body of claim 2 wherein the means for removing refuse material from the storage compartment comprises an ejector mechanism which includes:
(a) an ejector panel having an upper end and a lower end, said upper end being mounted between the sidewalls of the storage compartment for axial movement between a forward position and a rear position;
(b) means for moving the upper end of the ejector panel between the forward position and the rear position.

10. The body of claim 9:
(a) wherein the ejector panel is pivotally mounted about an ejector pivot axis at its upper end for pivotal movement between:
(i) a retracted orientation in which the lower end is disposed adjacent to the pivot end of the crusher panel when the ejector panel is in the forward position; and
(ii) an extended orientation in which the lower end is disposed rearwardly from the retracted position;
(b) wherein the upper end of the ejector panel may be moved between the forward position and the rear position when the ejector panel is in the extended orientation;
(c) which includes an ejector actuator that is located and arranged:
(i) to pivot the ejector panel about the ejector pivot axis between the retracted orientation and the extended orientation; and
(ii) to move the upper end of the ejector panel between the forward position and the rear position.

11. The body of claim 10 wherein the crusher panel and the ejector panel are located and arranged so that pivoting of the ejector panel from the retracted orientation to the extended orientation while the crusher panel is in the second orientation will sweep the lower end of the ejector panel across the crusher panel.

12. The body of claim 10 wherein the ejector mechanism includes an ejector over-center lock that is located and arranged to releasably lock the ejector panel in the extended orientation.

13. The body of claim 10 which includes an ejector cylinder drift lock that releasably locks the ejector panel in the retracted orientation.

14. The body of claim 13 wherein the ejector cylinder drift lock includes:
(a) a pivot pin;
(b) a latch which is attached to the pivot pin and adapted to releasably engage with the ejector panel;
(c) an air cylinder having:
(i) a piston rod which is attached to the pivot pin;
(ii) a spring that is adapted to bias the piston rod into an extended position in which the latch engages the ejector panel;
wherein the air cylinder is arranged, configured and adapted to actuate to overcome the bias of the spring so as to disengage the latch from the ejector panel prior to actuation of the ejector actuator.

15. The body of claim 10 wherein the ejector mechanism includes:
(a) an ejector panel having a pair of pivot pins mounted on opposite sides at the upper end thereof, said pins being co-axial with the ejector pivot axis;
(b) a pair of ejector guide tracks which are mounted opposite each other and disposed axially on the opposing sidewalls of the storage compartment;
(c) an ejector guide frame assembly having a pair of ejector guide frames which are mounted on opposite sides of the ejector panel, said guide frames being joined by a guide frame support extending between them, wherein said guide frame assembly:
(i) includes a pin socket within which a pivot pin will pivot as the ejector panel is pivoted between the retracted orientation and the extended orientation;
(ii) is adapted to move along the ejector tracks as the upper end of the ejector panel is moved axially between the forward position and the rear position.

16. The body of claim 15 wherein the ejector mechanism includes an ejector slide lock that is located and arranged on one of the ejector guide tracks near the open end of the storage compartment so as to releasably lock the ejector guide frame assembly to the ejector guide track when the upper end of the ejector panel is at the forward position.

17. The body of claim 16 wherein the ejector slide lock is associated with the ejector guide frame assembly and includes a linkage system that is mounted, arranged and configured so that when the ejector actuator has pivoted the ejector panel from the retracted orientation to the extended orientation, the slide lock will disengage so that the ejector panel may be moved from the forward position towards the rear position.

18. The body of claim 16 wherein the ejector slide lock is associated with the ejector guide frame assembly, which assembly includes the following components:
(a) a base link having a first end and a second end, said first end being pivotally mounted on the forward side of the ejector panel;
(b) a support link having a first end and a second end, said first end being pivotally mounted to the second end of the base link and said second end being pivotally mounted on the guide frame support;
(c) an intermediate link having a first end and a second end, said first end being pivotally mounted to the support link;
(d) a release link that is pivotally attached to one of the guide frames, which release link has a base end and a catch engagement end, said base end being pivotally mounted to the second end of the intermediate link;
(e) a catch link that is pivotally attached to the guide frame to which the release link is attached, said catch link having a catch end that is adapted to engage the ejector guide stop and a base end that is adapted to be engaged by the catch engagement end of the release link;
wherein the components of the ejector slide lock and the ejector actuator are mounted, arranged and configured so that as the ejector actuator pivots the ejector panel from the retracted position to the extended position, the catch link will disengage so that the ejector panel may be moved from the forward position towards the rear position.

19. A refuse collection vehicle having a frame with a front end and a rear end, an operator's cab at the front end of the frame, and a drivetrain for driving said vehicle across a roadway, said vehicle comprising:
(a) a hopper compartment mounted on the frame behind the cab, said hopper compartment comprising:
(i) a pair of opposing sidewalls defining a hopper compartment width;
(ii) a closed forward end;
(iii) an open rear end; and
(iv) a hopper compartment floor at a first level;
(b) a storage compartment mounted on the frame adjacent to and to the rear of the hopper compartment, said storage compartment comprising:
(i) a pair of opposing sidewalls defining a storage compartment width, said storage compartment width being no less than the hopper compartment width;
(ii) a forward end that opens into the hopper compartment;
(iii) a rear end having a tailgate mounted thereon; and
(iv) a storage compartment floor at a second level, said second level being raised above the first level;
(c) a transition floor between the hopper compartment floor at the first level and the storage compartment floor at the second level;
(d) a crusher assembly comprising:
(i) a header tube which is mounted between the sidewalls of the hopper compartment above the floor at the first level and adjacent to the transition floor;
(ii) a crusher panel having a pivot end and a sweep end, said pivot end being pivotally mounted on the header tube so that said crusher panel may be pivoted about a pivot axis at its upper end between a first orientation in which the sweep end is generally disposed above the pivot end and a second orientation in which the sweep end is adjacent to the storage compartment floor;
(iii) a crusher panel actuator for pivoting the crusher panel about its pivot axis between said first orientation and said second orientation;
wherein pivoting said crusher panel between said first orientation and said second orientation while refuse material is in the hopper compartment will cause said crusher panel to:
(iv) apply a downwardly directed compressive force to said refuse material in the hopper compartment; and
(v) sweep said refuse material from the hopper compartment into the storage compartment;
(e) an ejector panel having an upper end and a lower end, said upper end being mounted between the sidewalls of the storage compartment for axial and pivotal movement therein so that:
(i) the ejector panel may be pivoted about an ejector pivot axis at its upper end between a retracted orientation in which the lower end is disposed adjacent to the header tube and an extended orientation in which the lower end is disposed rearwardly from the retracted position;
(ii) the upper end of the ejector panel may be moved axially between a forward position and a rear position;
(f) an ejector actuator that is adapted:
(i) to pivot the ejector panel about the ejector pivot axis between the retracted orientation and the extended orientation; and
(ii) to move the upper end of the ejector panel between the forward position and the rear position.

20. The refuse collection vehicle of claim 19 which includes an apparatus for acquiring, lifting and transferring a container so as to deposit the contents of the container in the hopper compartment, said apparatus being mounted on the frame in front of the hopper compartment.
